(19) United States
(12) Patent Application Publication
(10) Pub. No.: US 2015/0292691 A1
(43) Pub. Date: Oct. 15, 2015

(54) UTILITY WORKING LIGHT APPARATUS

(71) Applicant: Bi Xin Li, Foshan (CN)

(72) Inventor: Bi Xin Li, Foshan (CN)

(21) Appl. No.: 14/484,222

(22) Filed: Sep. 11, 2014

(30) Foreign Application Priority Data
Oct. 11, 2013 (CN) 201320625763.6

(51) Int. Cl. F21L 4/08; F21V 23/04; F21V 21/096

(52) U.S. Cl. CPC F21L 4/085; F21V 21/0965; F21V 23/0421; F21Y 2103/003

(57) ABSTRACT

An utility working light apparatus comprising a switch cover unit, a handle end unit, a tube apparatus enclosed between the switch cover unit and the handle end unit, the switch cover unit comprising a first magnetic apparatus; the tube apparatus further comprising a PCB LED board; the handle end unit further comprising at least one sealing apparatus and a threaded end cap.

### INCORPORATION BY REFERENCE

This application claims the benefit of Chinese Patent Application No. 201320625763.6, filed Oct. 11, 2013, which is incorporated herein by reference in its entirety.

### FIELD OF THE INVENTION

The present invention generally relates to lighting technology, and, more particularly, a work light.

### BACKGROUND OF THE INVENTION

Work lights are widely used in automotive repair shops and other repair settings and construction settings. Such work lights are often in a form that can alternatively be handheld or hung from a suitable elevated object such as a raised automobile hood.

Currently, on the market, most of the work lights require a fixed running power source to power the light bulbs. In the situations such as underwater adventure, camping, road-side car fixing, outdoor living, etc., where a fixed running power source is not available, a self powered and portable work light is desired.

Even in the traditional settings where work lights have been used, the power cord is a drawback users want to eliminate because it clutters the already cluttered workspace, knocking down and tangling with tools and/or objects in the workspace. Furthermore, running power cord is a hazard if it tangles with and is damaged by a tool. Clearly, a work light without a power cord is desirable.

Furthermore, unlike incandescent and fluorescent work lights which often comprise at least one glass light bulb, LED work lights are better able to survive falls than are work lights that have glass bulbs. Furthermore, LEDs do not generally operate with parts hot enough to ignite flammable materials, so even falls that do result in breakage are less likely to cause fires than are similar falls of work lights that have glass bulbs.

The prior art has LED work lights, but because of the running power source requirement, their uses are limited to certain settings, i.e., automobile repair shop, indoor work, etc. Thus, they mostly produce one solid white or yellowish light. Therefore, they are inadequate to use in other settings, such as camping, outdoor games, road-side emergency, outdoor emergency, etc., where a multiple color or blinkable light source is desired to be used as a signal.

Moreover, in a submerging setting like an underwater adventure, a submerging electrical current is a hazard and a tangled power cord is a serious problem. Thus, most applications of current work lights are on land. Clearly, a cordless, self powered, and portable work light is desirable in these settings.

### OBJECT OF THE INVENTION

Accordingly, one objective of this invention is to provide a self powered work light.

Another objective of this invention is to provide a convenient portable work light.

Yet another objective of this invention is to provide a versatile work light.

Yet another objective of this invention is to provide a multiple color work light.

Yet another objective of this invention is to provide a blinkable work light.

Yet another objective of this invention is to provide a waterproof work light.

### SUMMARY OF THE INVENTION

In one aspect of the invention, an utility working light apparatus is disclosed comprising a switch cover unit, a handle end unit, a tube apparatus enclosed between the switch cover unit and the handle end unit, the switch cover unit comprising a first magnetic apparatus;

the tube apparatus further comprising a PCB LED board; the handle end unit further comprising at least one sealing apparatus and a threaded end cap. In one embodiment, the tube apparatus is a polycarbonate tube. In one embodiment, the polycarbonate tube is comprised of at least two difference shades. In one embodiment, the sealing apparatus is an O-ring. In one embodiment, the PCB LED board is capable of generating light brightness in multiple modes. In one embodiment, the PCB LED board is capable of generating light in terms of color in multiple modes. In one embodiment, the first magnetic apparatus is a magnetic ring. In one embodiment, the switch cover unit is further comprising of a push button switch. In one embodiment, the handle end unit is further comprising of a second magnetic apparatus. In one embodiment, the second magnetic apparatus is a magnetic block. In one embodiment, the handle end unit further comprising a USB charging connector. In one embodiment, the tube apparatus is further comprising of a battery charge indicator.

### BRIEF DESCRIPTIONS OF THE DRAWINGS

FIG. 1 is a schematic exploded view of an exemplary work light.

FIG. 2 is a perspective exploded view of an exemplary work light.

FIG. 3 is a side view of an exemplary switch cover.

### DETAILED DESCRIPTION OF THE INVENTION

The following detailed description of the preferred embodiments presents a description of certain specific embodiments as examples of a plurality of ways to practice this invention. As such, one may practice the present invention in a multitude of different embodiments as defined and covered by the claims.

In some instances, certain features are described in less or more detail. The level of detail associated with each of the elements or features should not be construed to qualify the novelty or importance of one feature over the others.

Certain marks referenced herein may be trademarks, whose use is to provide an enabling disclosure by way of example and shall not be construed to exclusively limit the scope of the disclosed subject matter to material associated with such marks.

References in this specification to “an embodiment”, “one embodiment”, “one or more embodiments” or the like, simply mean that the particular element, feature, structure or characteristic being described is in at least one embodiment of the disclosed subject matter. The occurrences of such phrases do not necessarily refer to the same embodiment, nor do they necessarily to mutually exclusive embodiments with respect to the discussed features or elements.

Various exemplary embodiments disclosed herein are directed to a work light that is convenient, versatile, and waterproof.

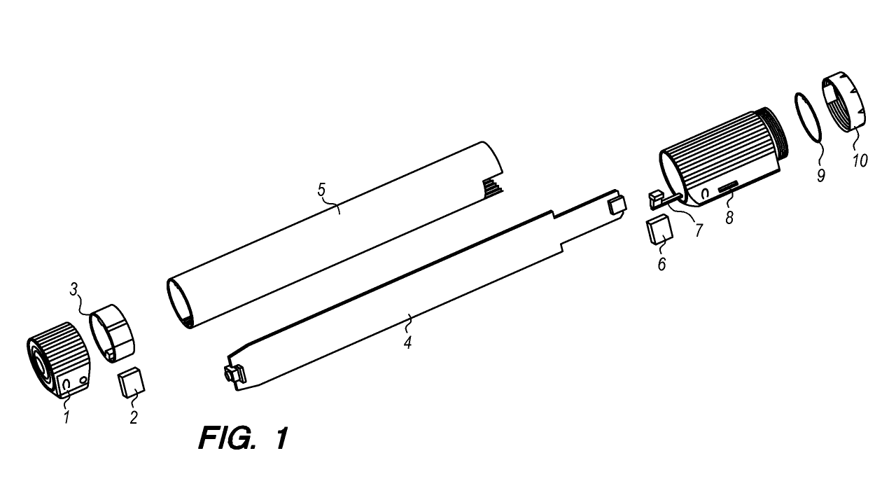

Referring to FIG. 1, in one embodiment, a work light comprises a switch cover 1, which prevents the switch from flipping in the event of a drop. The work light further comprises a strong magnetic ring 3 and a powerful magnet 2, which are positioned inside the female threaded cavity of the switch cover 1. The strong magnets can attach the work light to metal objects, fixtures or auto frames. The work light further comprises a Printed Circuit Board (PCB) light board 4, which is positioned inside a color tube 5, and their one ends are attached to the switch cover 1 such that the attachment is waterproof, using attaching methods appreciated by a person ordinarily skilled in the art. At the other ends of the PCB board 4 and color tube 5 are attached a powerful magnet 6, a strong magnetic block 7, and a handle end 8. Similarly, the attachment is made waterproof, and the magnets are positioned inside the cavity of the handle end 8. The strong magnets can also be used to attach the work light to metal objects, fixtures or auto frames. The other end of the handle end 8 is male threaded to receive an O-ring seal 9, and a female threaded end cap 10. The O-ring 9 and end cap 10 seal the work light from water and the elements. The cavity of the handle end 8 houses a rechargeable lithium battery.

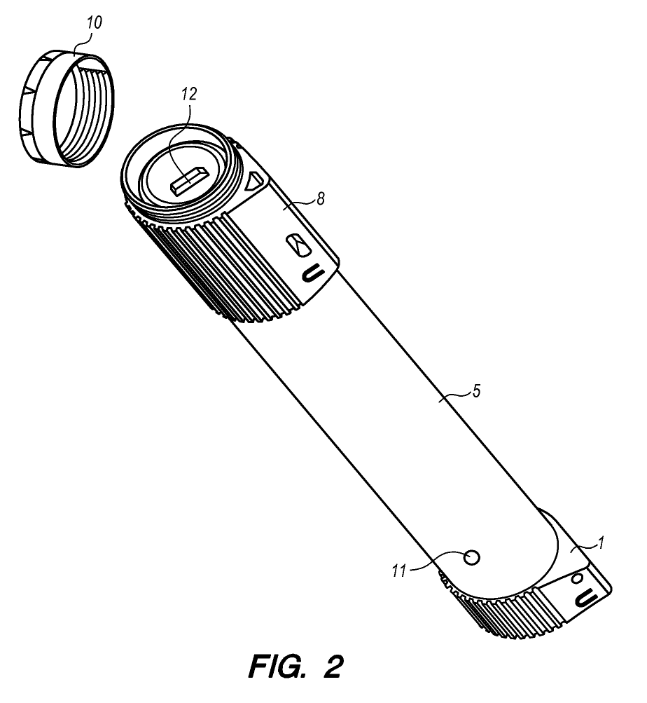

Referring to FIG. 2, in one embodiment, a work light comprises a switch cover 1, a color tube 5, a handle end 8, and a battery discharge indicator 11, that has a red, yellow, and green color indicators for a low, half power, and fully charged battery, respectively. The work light further comprises a USB charging jack 12 positioned in the cavity of the handle end 8 and facing the end cap 10. The USB charging jack 12 is used to charge the rechargeable lithium battery also positioned in the cavity of the handle end 8.

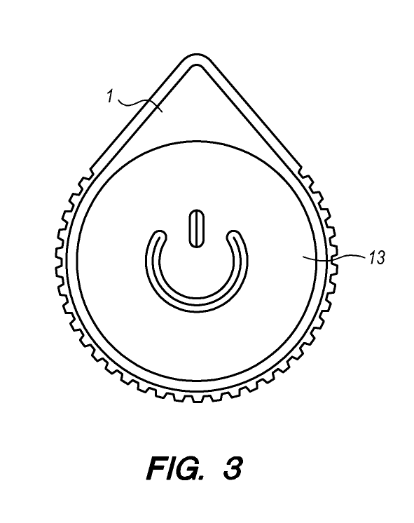

Referring to FIG. 3, in one embodiment, the work light comprises a switch cover 1 and a push-button switch 13, which is positioned inside the cavity of the switch cover. It is appreciated that the push-button switch 13 is made waterproof and seals the work light from water and the elements. In one embodiment, the push-button switch 13 can be long pressed to toggle the work light on and off.

In one embodiment, the PCB LED board 4 has eight light modes, where the first push-button switch 13 click produces a white light, the second click a red light, the third click a green light, the fourth click a blue light, the fifth click a red blinking light, the sixth click a red burst flash light, the seventh click a yellow blinking light, and the eighth click a yellow burst flash light.

In one embodiment, the PCB LED board 4 has five light modes, where the first click of the push-button switch 13 produces the strongest light in terms of brightness, the second click produces the normal light in terms of brightness, the third click generates mild light to save energy, a fourth click causes blinking light and the fifth click causes excess bright blinking light.

In one embodiment, the work light can be 6, 8, 10, 12, 15, 18, 24 inches, or longer. It is appreciated that the longer or larger the work light is, the more battery capacity may be required.

Although specific embodiments have been illustrated and described herein, it will be appreciated by those of ordinary skill in the art that any arrangement that is calculated or designed to achieve the same purposes may be substituted for the specific embodiments shown. Many adaptations of the disclosure will be apparent to those of ordinary skill in the art. Accordingly, this application is intended to cover any adaptations or variations of the disclosure.

1. An utility working light apparatus comprising a switch cover unit, a handle end unit, a tube apparatus enclosed between said switch cover unit and said handle end unit, said switch cover unit comprising a first magnetic apparatus; said tube apparatus further comprising a PCB LED board; said handle end unit further comprising at least one sealing apparatus and a threaded end cap.

2. The apparatus of claim 1 wherein said tube apparatus is a polycarbonate tube.

3. The apparatus of claim 2 wherein said polycarbonate tube is comprised of at least two difference shades.

4. The apparatus of claim 1 wherein said sealing apparatus is an O-ring.

5. The apparatus of claim 1 wherein said PCB LED board is capable of generating light brightness in multiple modes.

6. The apparatus of claim 1 wherein said PCB LED board is capable of generating light in terms of color in multiple modes.

7. The apparatus of claim 1 wherein said first magnetic apparatus is a magnetic ring.

8. The apparatus of claim 1 wherein said switch cover unit is further comprising of a push button switch.

9. The apparatus of claim 1 wherein said handle end unit is further comprising of a second magnetic apparatus.

10. The apparatus of claim 8 wherein said second magnetic apparatus is a magnetic block.

11. The apparatus of claim 1 wherein said handle end unit further comprising a USB charging connector.

12. The apparatus of claim 1 wherein said tube apparatus is further comprising of a battery charge indicator.
